(19) United States
(12) Patent Application Publication
(10) Pub. No.: US 2003/0099772 A1
(43) Pub. Date: May 29, 2003

(54) Method of manufacturing a luminescent screen for a CRT

(76) Inventors: Richard LaPeruta, JR., Lititz, PA (US); Steven Anthony Colbert, Lancaster, PA (US); Kangning Liang, Lancaster, PA (US)

Correspondence Address: Joseph S. Tripoli, THOMSON Multimedia Licensing Inc., Patent Operations, Two Independence Way, Post Office Box 5312, Princeton, NJ, 08540-5312, US

(21) Appl. No.: 09/988,513

(22) Filed: Nov. 20, 2001

(51) Int. Cl. B05D 5/12; B05D 1/32; B05D 3/02; B05D 1/36

(52) U.S. Cl. 427/282; 427/68; 427/384; 427/407.1; 427/402

(57) ABSTRACT

A method of manufacturing a luminescent screen assembly for a color cathode-ray tube (CRT). The luminescent screen assembly is formed on an interior surface of a faceplate panel of the CRT. The luminescent screen assembly includes an organic conductive (OC) layer overcoated with an organic photoconductive (OPC) layer. Different color-emitting phosphors are sequentially deposited over portions of the OPC layer and fixed with an appropriate fixative to secure the phosphors to the OPC layer, and then filmed to provide a smooth surface upon which a metal layer is applied. Thereafter, the metallized screen is baked to drive-off organic constituents remaining on the screen from the OPC, OC, filming and overspray layers. The organic constituents are removed from the metallized screen by volatilizing the organic materials such that the volume rate of gaseous organic constituents produced is less than the diffusion rate of such gaseous organic constituents through the metal layer.

### BACKGROUND OF THE INVENTION

1. Field of the Invention

The invention relates to a color cathode-ray tube (CRT) and, more particularly to a method of manufacturing a luminescent screen assembly for a color cathode-ray tube.

2. Description of the Background Art

A color cathode-ray tube (CRT) typically includes an electron gun, an aperture mask, and a screen. The aperture mask is interposed between the electron gun and the screen. The screen is located on an inner surface of a faceplate of the CRT. The aperture mask functions to direct electron beams generated in the electron gun toward appropriate color-emitting phosphors on the screen of the CRT.

The screen may be a luminescent screen. Luminescent screens typically comprise an array of three different color-emitting phosphors (e.g., green, blue, and red). Each color-emitting phosphor is separated one from others by a matrix line. The matrix lines are typically formed of a light-absorbing black inert material.

Luminescent screens may be formed using an electrophotographic screening (EPS) process. In EPS processes, an organic photoconductive (OPC) layer is sprayed over an organic conductive (OC) layer, formed on an interior surface of a CRT faceplate panel having matrix lines formed thereon. The three different color-emitting phosphors are then sequentially deposited on portions of the OPC layer.

After the three different color-emitting phosphors are sequentially deposited they are fixed with an appropriate fixative to secure the phosphors to the OPC layer, and then filmed to provide a smooth surface upon which a metal layer (e.g., aluminum (Al)) is applied after bakeable crystallites are formed on it through the overspray application. The metal layer reflects light generated in the color-emitting phosphors, which is directed toward the interior of the CRT tube, toward the viewer to enhance the brightness of the light emitted from the screen. Thereafter, the metallized screen is baked to drive-off organic constituents remaining on the screen from the OPC, OC, filming and overspray layers. The process steps of applying the appropriate organic materials and depositing the phosphor lines is known as screening.

During the screen baking process, gaseous organic constituents from the organic layers are produced. Such gaseous organic constituents escape from the screen through pre-existing pinholes in the metal layer. One drawback with such a screen baking process is that some of the gaseous organic constituents may become trapped under the metal layer when the screen is baked. The trapped gaseous organic constituents may deform the structure of the metal layer forming blisters therethrough.

Thus, a need exists for a screen baking process that overcomes the above-mentioned drawback.

### SUMMARY OF THE INVENTION

The present invention relates to a method of manufacturing a luminescent screen assembly for a color cathode-ray tube (CRT). The luminescent screen assembly is formed on an interior surface of a faceplate panel of the CRT. The method includes the steps of providing a luminescent screen assembly having a metal layer formed on organic materials on the surface thereof; removing the organic materials from the surface of the luminescent screen assembly by volatilizing the organic materials such that the volume rate of gaseous organic constituents produced is less than the diffusion rate of such gaseous organic constituents through the metal layer.

### BRIEF DESCRIPTION OF THE DRAWINGS

The invention will now be described in greater detail, with relation to the accompanying drawings, in which:

FIG. 1 is a plan view, partly in axial section, of a color cathode-ray tube (CRT) made according to the present invention;

FIG. 2 is a section of a faceplate panel portion of the CRT depicted in FIG. 1, showing a screen assembly; and

FIG. 3 is a block diagram comprising a flow chart of the manufacturing process for the screen assembly of FIG. 2.

### DETAILED DESCRIPTION OF THE INVENTION

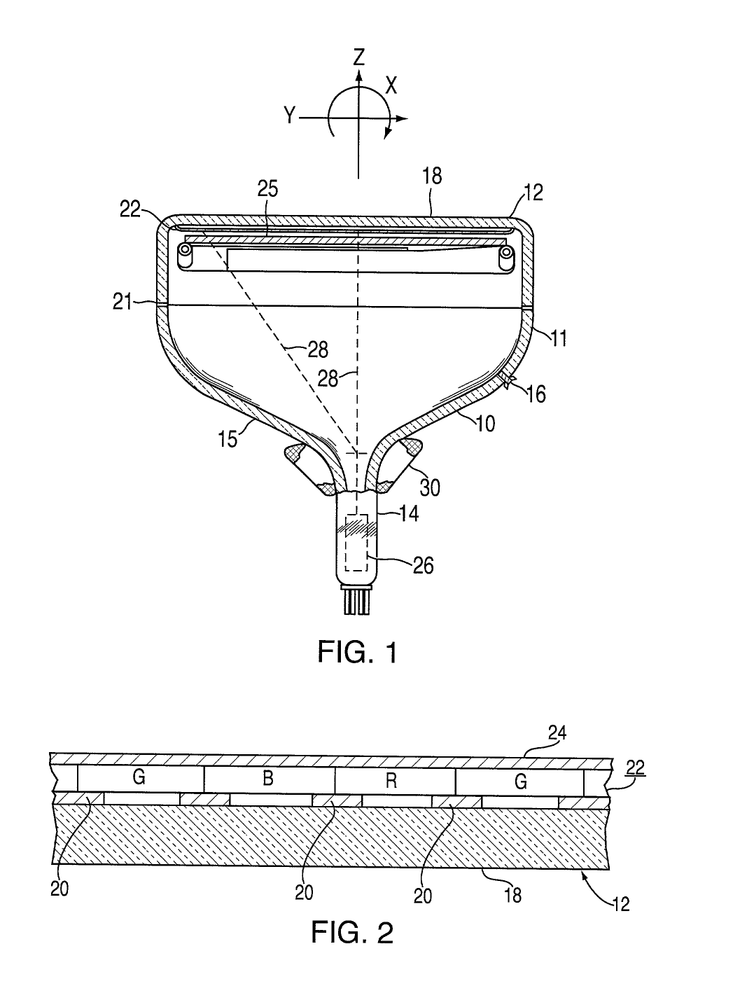

FIG. 1 shows a color cathode-ray tube (CRT) 10 having a glass envelope 11 comprising a faceplate panel 12 and a tubular neck 14 connected by a funnel 15. The funnel 15 has an internal conductive coating (not shown) that is in contact with, and extends from, an anode button 16 to the neck 14.

The faceplate panel 12 comprises a viewing faceplate 18 and a peripheral flange or sidewall 23 that is sealed to the funnel 15 by a glass frit 21. A three-color luminescent phosphor screen 22 is carried on the inner surface of the faceplate 18. The screen 22, shown best in FIG. 2, is a line screen which includes a multiplicity of screen elements comprising red-emitting, green-emitting, and blue-emitting phosphor stripes R, G, and B, respectively, arranged in color groups or picture elements of three stripes or triads, in a cyclic order with each triad including a phosphor line of each of the three colors. The R, G, B phosphor stripes extend in a direction that is generally normal to the plane in which the electron beams are generated.

A light-absorbing matrix 20 separates each of the R, G, B phosphor lines. A thin conductive metallizing layer 24 overlies the screen 22 and provides means for applying a uniform first anode potential to the screen 22, as well as for reflecting light, emitted from the phosphor elements, through the faceplate 18. The screen and the overlying conductive metallizing layer 24 comprise a screen assembly. A multi-aperture color selection electrode, or shadow mask 25 (shown in FIG. 1), is removably mounted, by conventional means, within the faceplate panel 12, in predetermined spaced relation to the screen assembly.

An electron gun 26, shown schematically by the dashed lines in FIG. 1, is centrally mounted within the neck 14, to generate and direct three inline electron beams 28, a center and two side or outer beams, along convergent paths through the shadow mask 25 to the screen 22. The inline direction of the center beam is approximately normal to the plane of the paper.

The CRT of FIG. 1 is designed to be used with an external magnetic deflection yoke, such as the yoke 30, shown in the neighborhood of the funnel-to-neck junction. When activated, the yoke 30 subjects the three electron beams 28 to magnetic fields that cause the beams to scan a horizontal and vertical rectangular raster across the screen 22.

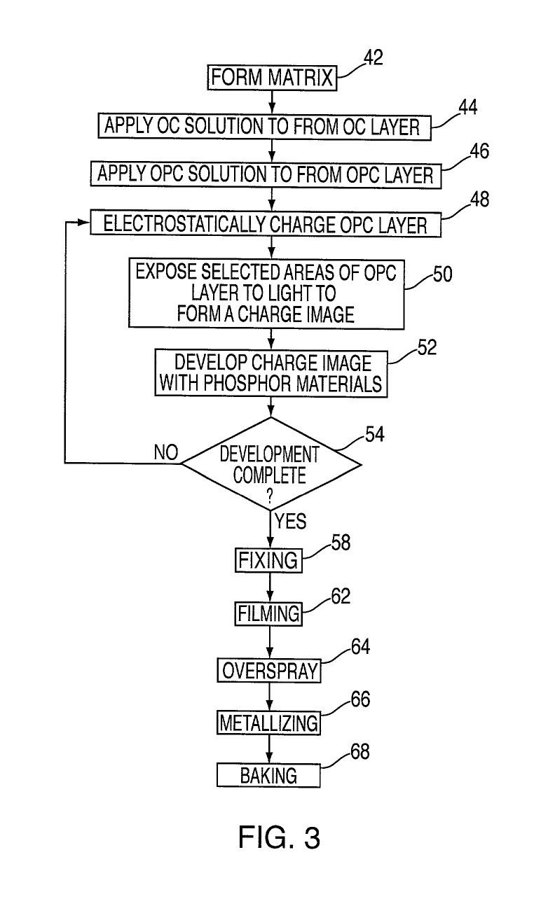

The screen 22 is manufactured using an electrophotographic screening (EPS) process that is shown schematically in FIG. 3. Referring to reference numeral 42 of FIG. 3, the interior surface of the viewing faceplate 18 is provided with the light-absorbing matrix 20, as is known in the art. The light-absorbing matrix 20 is a series of substantially parallel lines having spaces therebetween referred to as openings.

Referring to step 44 of FIG. 3, the interior surface of the viewing faceplate 18, having a matrix 20 thereon, is then coated with a suitable layer of a volatilizable, organic conductive (OC) material. The OC layer typically has a thickness within a range of about 0.5 microns to about 3.5 microns.

Suitable materials for the OC layer include a polymer of a polymethacrylate and a polythiophene. A suitable organic conductor is OC-10, which consists mainly of poly(2-hydroxyethyl methacrylate) (PHEM) and a conductive polythiophene compound (Baytron-P). The solid coating of OC-10 contains about 22 weight % Baytron-P. Quaternary ammonium polyelectrolytes such as, for example, poly(dimethyl-diallyl-ammonium chloride), poly(3,4-dimethylene-N-dimethylpyrrolidium chloride)(3,4-DNDP chloride), poly(3,4-dimethylene-N-dimethylpyrrolidium nitrate)(3,4-DNDP nitrate), and poly(3,4-dimethylene-N-dimethylpyrrolidium phosphate)(3,4-DNDP phosphate) may also be used for the OC layer. Alternatively, 3,4-polyethylenedioxythiophene-polystyrenesulfonate (cationic) or vinylimidazolium methosulfate (VIM) vinylpyrrolidone (VP) copolymer may be used. The OC material may also include oxidizing agents such as sodium perchlorate, potassium perchlorate, sodium chlorate, potassium chlorate, sodium nitrate, and potassium nitrate, where an effective quantity has an oxidizing power corresponding to at least 0.075 moles of oxygen in the case of a 30-inch panel having a 16×9 aspect ratio. The oxidizing agents facilitate the removal of the remaining organic constituents during cap bakes under oxygen-deficient conditions.

An organic photoconductive (OPC) layer is formed over the OC layer as indicated in step 46. The OPC layer is formed by overcoating the OC layer with an OPC solution containing a polystyrene resin, an electron donor material, such as 1,4-di(2,4-dimethyl phenyl)-1,4-diphenylbutatriene (2,4-DMPBT), electron acceptor materials, such as 2,4,7-trinitro-9-fluorenone (TNF) and 2-ethylanthroquinone (2-EAQ), and a suitable solvent, such as toluene, xylene, or a mixture of toluene and xylene. A surfactant, such a silicone U-7602, and a plasticizer, such as dioctyl phthalate (DOP), may also be added to the OPC solution. The surfactant U-7602 is commercially available from Union Carbide, Danbury, Conn.

The composition of the OPC solution preferably comprises about 4.8% by weight to about 7.2% by weight of the polystyrene resin, about 0.8% by weight to about 1.3% by weight of the electron donor material (2,4-DMBPT), about 0.04% by weight to about 0.06% by weight of TNF and about 0.12% by weight to about 0.36% by weight of 2-EAQ, as electron acceptor materials, about 0.3% by weight of a plasticizer (DOP), about 0.01% by weight of a surfactant (silicone U-7602), and the balance comprising a suitable solvent or solvents such as toluene and xylene.

After the OPC layer is applied, it is uniformly electrostatically charged, as indicated by reference numeral 48, using a corona discharge device (not shown). The OPC layer is typically charged to a voltage within a range of about +200 volts to about +700 volts. Thereafter, the shadow mask 25 is inserted into the faceplate panel 12, placed in a lighthouse (not shown), and exposed, through the shadow mask, to light from a suitable light source disposed within the lighthouse. The light passes through the apertures in the shadow mask, at angles identical to those of the electron beams from the electron gun of the tube, discharging the illuminated first phosphor areas on the OPC layer so as to form charge images, as indicated by reference numeral 50.

The shadow mask 25 is removed from the faceplate panel 12, and the panel is placed onto a first phosphor developer containing, first color-emitting phosphor material, to develop the charge image, as indicated by reference numeral 52. The first color-emitting phosphor material is positively triboelectrical charged within the developer and directed toward the OPC layer. The positively charged first color-emitting phosphor material is repelled by the positively charged areas on the OPC layer and deposited onto the discharged areas thereof by the process known in the art as “reversal” development. In reversal development, triboelectrically charged particles of phosphor material are repelled by similarly charged areas of the OPC layer and deposited onto the discharged areas thereof. Because a total of three different color-emitting phosphors are required to form the screen 22, the light exposure step 50 and the phosphor development step 52 are repeated for each of the other two color-emitting phosphors, as indicated by reference numeral 54 in FIG. 3.

The three color-emitting phosphors are fixed to the OPC layer by contacting the phosphors with a suitable fixative composition, as indicated by step 58 in FIG. 3. Suitable fixative compositions comprise mixtures of solvents such as methyl isobutyl ketone (MIBK) and d-limonene. The fixative mixture preferably combines the MIBK and the d-limonene in a ratio of about 2:1. The fixative composition can be applied to the color-emitting phosphors using the electrostatic spray system.

After the color-emitting phosphors are fixed, they are filmed, as indicated by step 62 in FIG. 3, to provide a smooth surface over the screen 22 onto which an evaporated metal layer (e.g., aluminum (Al)) can be deposited. The screen 22 is filmed by applying a polymeric solution over the fixed phosphor screen elements.

The filming composition comprises about 3% to about 10% by weight of an acrylic polymer. Suitable acrylic polymers include butyl methacrylate and polymethylmethacrylate, among others. The filming composition is preferably deposited on the fixed phosphors using an electrostatic spray module. As indicated by step 64, an overspray of aqueous boric acid or ammonium oxalate is sprayed into the filmed surface.

After the color-emitting phosphors are fixed, filmed, and oversprayed, a metal layer is evaporated thereover, as indicated by reference numeral 66 in FIG. 3. Suitable materials for the metal layer include aluminum (Al), among others. The overspray step, as indicated by reference numeral 64, induces pinholes in the metal layer, through which gaseous organic constituents escape during the subsequent bake step.

Thereafter, the metallized screen is baked to drive-off organic constituents remaining on the screen from the OPC, OC, filming, and overspray layers, as indicated by reference numeral 68 in FIG. 3. The organic constituents are removed from the metallized screen by volatilizing the organic materials such that the volume rate of gaseous organic constituents produced is less than the diffusion rate of such gaseous organic constituents through the metal layer. The volume rate of gaseous organic constituents produced is controlled by adjusting the screen bake temperature as a function of the volume of gaseous organic constituents predicted to be formed during the electrophotographic screening (EPS) process. Controlling the volume rate of gaseous organic constituents that are produced during the screen bake step, prevents the formation of excess gaseous organic constituents that may deform the structure of the metal layer forming blisters therethrough.

Understanding the thermal decomposition temperatures of the major components of materials used for the EPS process is of great importance to the screen bake step. In particular, the thermal decomposition temperatures of the OC layer, the OPC layer, the filming layer, and the overspray layer determine the amounts of gaseous organic constituents produced.

For example, an EPS process using OC-10 as the organic conductor consists mainly of poly (2-hydroxyethyl methacrylate) (PHEM). Poly (2-hydroxyethyl methacrylate) (PHEM) belongs to the family of polymethylmethacrylate (PMMA). Thermal degradation of PMMA based polymers occurs by a mechanism referred to as “unzipping”. In the “unzipping” mechanism, monomer fragments comprising, for example, methyl and ester groups split off stepwise along the polymer chain from free radicals formed during scission. A faceplate panel having a diagonal dimension of about 30 inches for a 16×9 aspect ratio contains about 0.38 g of OC-10 materials, which corresponds to about 0.003 moles of gaseous 2-hydroxylethyl methacrylate at thermal decomposition temperatures. The decomposition temperature range for OC-10 is about 280° C. to about 450° C.

Polystyrene (PS) is the major component in the OPC coating. As such, the bakeout of OPC can be considered as the thermal degradation of polystyrene. The degradation of polystyrene occurs by random scission, forming a mainly aromatic composition dominated by styrene and styrene oligomers. A faceplate panel having a diagonal dimension of about 30 inches for a 16×9 aspect ratio contains about 1.4 g of OPC materials, which corresponds to about 0.013 moles of gaseous styrene at thermal decomposition temperatures. The decomposition temperature range for PS is about 340° C. to about 400° C.

The third layer of the EPS process is the filming layer, which provides a smooth surface for the metal layer of the faceplate panel. The filming layer primarily comprises polymethyl methacrylate (PMMA). As described above for the OC layer, thermal degradation of PMMA occurs via an “unzipping” mechanism forming monomer fragments comprising, for example, methyl and ester groups. A faceplate panel having a diagonal dimension of about 30 inches for a 16×9 aspect ratio contains about 2.1 g of PMMA, which corresponds to about 0.021 moles of gaseous polymethyl methacrylate at thermal decomposition temperatures. The decomposition temperature range for PMMA is about 240° C. to about 350° C.

The overspray layer for a metalized layer results from the application of a solution including about 3% by weight of ammonium oxalate monohydrate (AOM). The thermal decomposition of ammonium oxalate monohydrate (AOM) proceeds via three steps. In the first step, ammonium oxalate monohydrate is dehydrated to form ammonium oxalate (OA). In the second step, the ammonium oxalate partially decomposes forming ammonia gas and ammonium hydrogen oxalate (AHO). In the third step, the ammonium hydrogen oxalate decomposes into ammonia, water vapor, carbon monoxide and carbon dioxide. A faceplate panel having a diagonal dimension of about 30 inches for a 16×9 aspect ratio contains about 1.0 g of ammonium oxalate monohydrate (AOM), which corresponds to about 0.042 moles of gaseous ammonia, water vapor, carbon monoxide and carbon dioxide at thermal decomposition temperatures. The decomposition temperature range for AOM is about 230° C. to about 29° C.

Table I summarizes the volumes of gases produced by each component in the EPS process described above, calculated using

$$V = \frac{nRT}{P} \qquad ( 1 )$$

where V is the volume (L) of the gas produced, n is the number of moles of gas, R is the universal gas constant (0.08205 L atm/mol K), P is the pressure (atm) of the gas, and T is the temperature (K) of the gas. As shown in Table I, the volume of gases generated from PHEM (OC-10) is negligible compared to other components. The two largest gas generators AOM (overspray) and PMMA (filming) show the onset of decomposition at about 230° C., therefore a slow rate of temperature increase should be used before 230° C. Almost all of the masses of AOM and PMMA are vaporized below 350° C., indicating a faster rate of temperature increase can be used thereabove.

TABLE I

| | | Calculated | Decomposition |
|---|---|---|---|
| Substance | Moles of Gas | Volume (L) | Range (° C.) |
| PHEM | 0.003 | 0.073 | 280-450 |
| PS | 0.013 | 0.32 | 340-400 |
| PMMA | 0.021 | 0.51 | 240-350 |
| AOM | 0.042 | 1.0 | 230-290 |

Based on the thermal decomposition data provided in Table I, an example of a suitable bake-out process is provided in Table II utilizing seven (7) steps.

TABLE II

| | | Rate of | |
|---|---|---|---|
| | Temperature | Temperature | Time Required |
| Process Step | Range (° C.) | Increase (° C./min) | (min) |
| A | 23-225 | 9.0 | 22.4 |
| B | 225-240 | 1.0 | 15 |
| C | 240-300 | 0.75 | 80 |
| D | 300-350 | 2.0 | 25 |
| E | 350-460 | 9.0 | 12.2 |
| F | 460-460 | 0 | 70 |
| G | 450-30 | −4.0 | 105 |

The temperature range of step A falls within a range where no major thermal decomposition reactions occur. Therefore, the temperature can be increased using a rate of about 9.0° C./min, without the risk of forming a large volume of gaseous organic constituents.

Gaseous organic constituents from the AOM and PHEM materials begin to form during the temperature range of step B. As such, the temperature is increased at a slower rate of about 1° C./min, to prevent vigorous production of gaseous organic constituents.

The majority of the gaseous organic constituents from the EPS materials are formed during the temperature range of step C. The temperature is increased at a slow rate of about 0.75° C./min, to provide a slow rate of volatilization for the gaseous organic constituents.

A relatively small amount of gaseous organic constituents remain after the thermal decomposition of step C. As a result, in thermal decomposition step D, the temperature is increased at a faster rate of about 2.0° C./min.

Thermal decomposition steps E and F are designed to remove any remaining organic constituents from the faceplate panel. As such, thermal decomposition step E is used to increase the temperature at a fast rate of about 9.0° C./min to a maximum temperature of about 460° C. Thereafter, thermal decomposition step F is used to hold the temperature at the maximum temperature of 460° C. for a fixed period of time.

After the gaseous organic constituents have been removed from the faceplate panel, thermal decomposition step G is used to cool the faceplate panel down to room temperature by decreasing the temperature at a rate as fast as that which the glass can handle without breaking. A suitable rate is about 4° C./min.

Alternatively, the organic constituents may be removed from the metallized screen using a two-step process wherein a portion of the gaseous organic constituents are removed during a screenbake step, with the remaining gaseous organic constituents being removed during a frit curing step. The portion of the gaseous organic constituents may be removed during the screen bake step using a lower rate of volatilization to reduce the risk of metal blistering. Additionally, oxidizing agents such as, for example, sodium perchlorate, potassium perchlorate, sodium chlorate, potassium chlorate, sodium nitrate, or potassium nitrate can be included in the organic conductor (OC) layer to facilitate the removal of organic constituents during the frit cure step.

An example of a suitable two-step screen-bake process may include an initial bake cycle at 300° C. for up to 3 hours. During the initial screen bake cycle the rate of volatilization for the organic constituents should be less than about 1.10 wt. %/min. Thereafter, the remaining gaseous organic constituents may be removed during the frit curing step. During the frit curing step the faceplate panel is heated to a temperature of about 450° C. for up to about 4 hours. The rate of volatilization for the organic constituents should be less than about 2.5 wt. %/min. If an oxidizer is not included in the OC layer, oxygen may be provided during the frit cure step to facilitate the removal of organic constituents during such frit cure step.

As the embodiments that incorporate the teachings of the present invention have been shown and described in detail, those skilled in the art can devise other varied embodiments that incorporate these teachings without departing from the spirit of the invention.

What is claimed is:

1. A method of manufacturing a luminescent screen assembly for a color cathode-ray tube (CRT), comprising the steps:
screening an inner surface of a faceplate panel, thereby providing on the inner surface a screened surface having phosphor deposits and organic materials, the organic materials having at least two components with different thermal decomposition characteristics, at least some of the organic materials overlie the phosphor deposits;
depositing a metal layer on the organic materials; and,
removing the organic materials from the inner surface of the faceplate panel by volatilizing the organic materials through heating such that volume rates of gaseous decomposition products from each of the components is less than diffusion rates of the respective gaseous decomposition products through the metal layer.

2. The method of claim 1 wherein the organic materials applied to the surface of faceplate panel have a composite screen weight of greater than about 1.0 mg/cm².

3. The method of claim 1 wherein the volume rate of the gaseous decomposition products produced is controlled by adjusting rates of temperature increase.

4. The method of claim 3 wherein more than one rate of temperature increase is used to control separately the volume rates of the gaseous decomposition products produced.

5. A method of manufacturing a luminescent screen assembly for a color cathode-ray tube (CRT), comprising the steps:
providing a luminescent screen assembly, wherein the luminescent screen assembly includes a metal layer formed on organic materials applied to the surface of a faceplate panel of the tube;
heating the assembly to a temperature to diffuse a portion of the organic materials through the metal layer during a screenbake step, and subsequently heating the assembly to a temperature to diffuse remaining organic materials through the metal layer during a frit curing step wherein diffusion rates of the organic materials through the metal layer is greater than the volume rate of gaseous decomposition products of the organic materials formed during heating steps.

6. The method of claim 5 wherein an oxygen source is provided during the frit curing step.

7. The method of claim 5 wherein the organic materials include an oxidizer.

8. The method of claim 7 wherein the oxidizer is sodium perchlorate, potassium perchlorate, sodium chlorate, potassium chlorate, sodium nitrate, or potassium nitrate.

9. The method of claim 7 wherein the organic materials are volatilized at a rate of less than about 1.10 wt. %/min during the screenbake step.

10. The method of claim 7 wherein the organic materials are volatilized at a rate of less than about 2.5 wt. %/min during the frit curing step.

11. A method of manufacturing a luminescent screen assembly for a color cathode-ray tube (CRT), comprising the steps:
providing a luminescent screen assembly to the inner surface of a faceplate panel, wherein the luminescent screen assembly includes a metal layer formed on organic materials applied to the surface thereof, the organic materials having at least two components with different thermal decomposition characteristics;
exposing the luminescent screen assembly to a first temperature rate increase that ends at a first temperature at which a first component begins to volatilize;
exposing the luminescent screen assembly to a second temperature rate increase that starts at the first temperature and ends at a second temperature to volatilize the first component;
exposing the luminescent screen assembly to a third temperature rate increase that starts at the second temperature and ends at a third temperature to volatilize a second component; and
exposing the luminescent screen to any additional temperature rates increases to volatilize any additional components, thereby removing the organic materials from the screen such that the screen assembly can be processed into the CRT and wherein each of the temperature rate increases creates gaseous decomposition products at volume rates that are less than respective diffusion rates of the respective gaseous decomposition products.

12. The method of claim 11 wherein:
the first temperature rate increase is up to an average value of 9.0° C./min for at least 22.4 min, the first temperature rate ends at about 225° C. and begins to volatilize the first component;
the second temperature rate increase is up to an average value of 1.0° C./min for at least 15 min, the second temperature rate increase starts at about 225° C. and ends at a about 240° C. to volatilize the first component;
the third temperature rate increase is up to an average value of 0.75° C./min for at least 80 min, the third temperature rate increase starts at about 240° C. and ends at about 300° C. to volatilize the second component; and
additional temperature rate increases are incorporated in additional steps of:
exposing the luminescent screen assembly to a fourth temperature rate increase is up to an average value of 2.0° C./min for at least 25 min, the fourth temperature rate increase starts at about 300° C. and ends at about 350° C. to volatilize a third component; and
exposing the luminescent screen assembly to a fifth temperature rate increase is up to an average value of 9.0° C./min for at least 12.2 min, the fifth temperature rate increase starts at about 350° C. and ends at about 460° C. to volatilize a fourth component.

13. The method of claim 12 wherein the first component comprises ammonium oxalate monohydrate (AOM) and polymethylmethacrylate (PMMA).

14. The method of claim 12 wherein the second component comprises ammonium oxalate monohydrate (AOM), polymethylmethacrylate (PMMA) and poly(2-hydroxyethyl methacrylate) (PHEM).

15. The method of claim 12 wherein the third component comprises polystyrene (PS), polymethylmethacrylate (PMMA) and poly(2-hydroxyethyl methacrylate) (PHEM).

16. The method of claim 12 wherein the fourth component comprises polystyrene (PS) and poly(2-hydroxyethyl methacrylate) (PHEM).
